(19) United States
(12) Patent Application Publication
(10) Pub. No.: US 2014/0066068 A1
(43) Pub. Date: Mar. 6, 2014

(54) MOBILE TERMINAL, MOBILE COMMUNICATION METHOD, AND MOBILE COMMUNICATION SYSTEM

(71) Applicant: FUJITSU LIMITED, Kawasaki-shi (JP)

(72) Inventor: Takahito SUZUKI, Zushi (JP)

(21) Appl. No.: 13/925,164

(22) Filed: Jun. 24, 2013

(30) Foreign Application Priority Data
Aug. 28, 2012 (JP) 2012-187846

(51) Int. Cl. H04W 36/24

(52) U.S. Cl. CPC H04W 36/245
USPC 455/436

(57) ABSTRACT

A mobile terminal, includes: a memory configured to store a cell selection data pattern, the cell selection data pattern being used to select a radio access technology utilized by the mobile terminal, in a manner to associate the cell selection data pattern with an operating state capable of being taken by the mobile terminal; and a processor coupled to the memory, configured to select one of the radio access technologies utilized by the mobile terminal, by using a cell selection data pattern that is selected from the memory based on the operating state of the mobile terminal, and performs connection processing with respect to a cell by using the selected radio access technology.

### CROSS-REFERENCE TO RELATED APPLICATION

This application is based upon and claims the benefit of priority of the prior Japanese Patent Application No. 2012-187846, filed on Aug. 28, 2012, the entire contents of which are incorporated herein by reference.

### FIELD

The embodiment discussed herein is related to a mobile terminal, a mobile communication method, and a mobile communication system.

### BACKGROUND

There is a technique (for example, Japanese Laid-open Patent Publication No. 2007-97122) wherein a plurality of pieces of cell information having different priorities in a hierarchical cell structure are received, and in accordance with the received cell information and remaining battery amount, a cell measuring reference is re-configured so that connection is made with a cell selected from cells which are measured in accordance with the re-configured measurement reference.

There is a technique (for example, Japanese Laid-open Patent Publication No. 2009-170981) wherein at least one communication parameter which exerts influence on receiving quality and power consumption is selected based on speed information and remaining battery amount, so as to set the selected communication parameter in a transceiving unit in a mobile communication terminal.

There is a position registration control system (for example, Japanese Laid-open Patent Publication No. 2010-81342) wherein a position registration area in a network control device and a mobile terminal are dynamically changed in accordance with remaining battery amount, so as to improve battery consumption of the mobile terminal.

There is a technique (for example, Japanese Laid-open Patent Publication No. 2008-182378) wherein a communication rate is decided on the basis of remaining amount and electric current consumption of a battery and the transfer speed of a terminal, and communication parameters of the terminal are further set so as to perform communication according to a state of the battery.

### SUMMARY

According to an aspect of the embodiment discussed herein, a mobile terminal, includes: a memory configured to store a cell selection data pattern, the cell selection data pattern being used to select a radio access technology utilized by the mobile terminal, in a manner to associate the cell selection data pattern with an operating state capable of being taken by the mobile terminal; and a processor coupled to the memory, configured to select one of the radio access technologies utilized by the mobile terminal, by using a cell selection data pattern that is selected from the memory based on the operating state of the mobile terminal, and performs connection processing with respect to a cell by using the selected radio access technology.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of selection of a serving cell performed by a mobile terminal according to an embodiment;

FIG. 2 illustrates the mobile terminal according to the present embodiment;

FIG. 3 illustrates saving-mode data according to the present embodiment;

FIG. 4 illustrates correlation between battery amount and a remaining battery amount level according to the present embodiment;

FIG. 5 illustrates a cell selection data table according to the present embodiment;

FIG. 6A illustrates the relation between constituent elements of the mobile terminal according to the present embodiment;

FIG. 6B illustrates the relation between constituent elements of the mobile terminal according to the present embodiment;

FIG. 6C illustrates the relation between constituent elements of the mobile terminal according to the present embodiment;

FIG. 6D illustrates the relation between constituent elements of the mobile terminal according to the present embodiment;

FIG. 6E illustrates the relation between constituent elements of the mobile terminal according to the present embodiment;

FIG. 7A illustrates the relation between constituent elements of the mobile terminal according to the present embodiment;

FIG. 7B illustrates the relation between constituent elements of the mobile terminal according to the present embodiment;

FIG. 7C illustrates the relation between constituent elements of the mobile terminal according to the present embodiment;

FIG. 7D illustrates the relation between constituent elements of the mobile terminal according to the present embodiment;

FIG. 7E illustrates the relation between constituent elements of the mobile terminal according to the present embodiment;

FIG. 8 illustrates an example of operations when the remaining battery amount is low in the mobile terminal according to the present embodiment;

FIG. 9 illustrates an example of operations when change of a function used in the mobile terminal according to the present embodiment is detected;

FIG. 10 illustrates an example of operations related to reselection of a standby cell in the mobile terminal according to the present embodiment; and

FIG. 11 illustrates an example of operations related to hand-over in the mobile terminal according to the present embodiment.

### DESCRIPTION OF EMBODIMENT

An embodiment of the present disclosure is described below with reference to the accompanying drawings.

Data appearing in the present embodiment are described in a natural language. However, the data are specifically designated by a pseudo-language which is recognizable by a computer, such as a command, a parameter, or a machine language.

While inventing the present embodiments, observations were made regarding a related art. Such observations include the following, for example.

Reducing power consumption (battery saving) in a mobile terminal of the related art is an important issue. This issue has been increasingly emphasized in recent years with the start of services that use communication standards enabling high-speed communication, such as long-term evolution (LTE), and dissemination of mobile terminals that consume a considerable amount of power, such as a smartphone.

It is commonly known that power consumption of a mobile terminal is increasing with the use of communication standards for radio access technology (RAT) that enables high-speed communication, because the frequency band used in such communication standards is larger than previous standards. Further, it may be conceived that high-speed communication is not demanded depending on the usage environment or usage conditions of a user.

In particular, when remaining battery amount is low, if participation in a RAT cell, which enables high-speed communication and involves high power consumption, is maintained even though a user desires to suppress power consumption, usable life of the battery is shortened.

With a mobile terminal capable of standby and communication in cells for a plurality of radio access technologies, the present disclosure aims to provide a technique which enables selection of a cell of an appropriate radio access technology while taking an operating state of the mobile terminal into account.

[Example of Selection of Serving Cell]

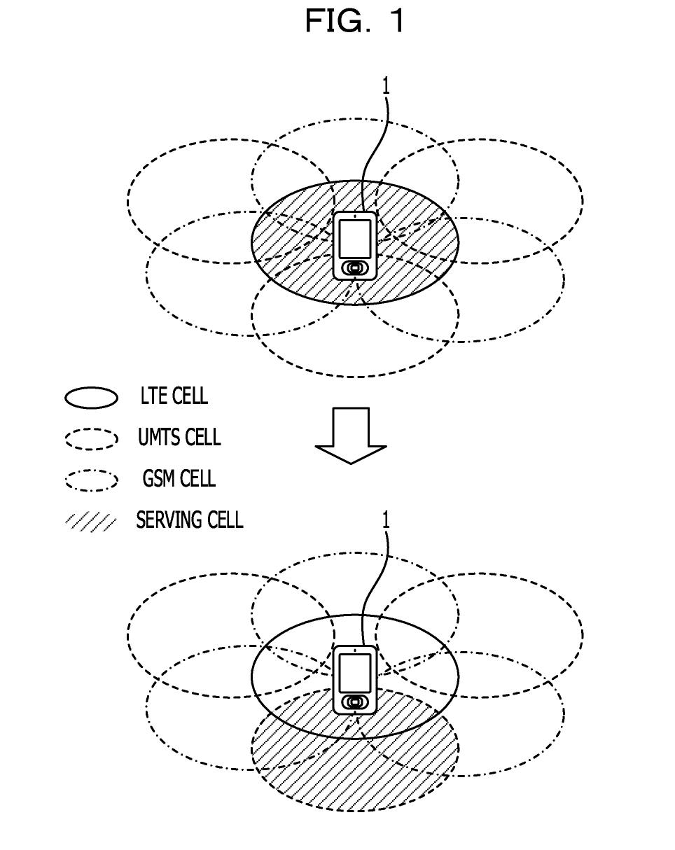

FIG. 1 illustrates an example of selection of a serving cell performed by a mobile terminal 1 according to an embodiment of the present disclosure. The mobile terminal 1 according to the present embodiment is capable of selecting a cell of a plurality of different RATs, standing by, performing connection processing with respect to a base station of the RAT to which the cell selected from the cells of the plurality of RATs belongs, and communicating.

The mobile terminal 1 includes a storage device that stores a plurality of cell selection data patterns corresponding to a plurality of combinations of a remaining battery amount and an available function and are used for selecting one of a plurality of cells formed by a plurality of radio access technologies that are different from each other.

Here, examples of an available functionality includes an application function which is practicable in the mobile terminal 1, such as a mobile television function, a player function for music/video, and a camera function, as well as functionality for receiving communication services (such as e-mail, a voice call, or a streaming service of sound/video). The available functionality in the mobile terminal 1 is not limited to these functions, but may be arbitrarily selected depending on the make-up of an embodiment.

As an example of a plurality of types of radio access technologies which are different from each other, FIG. 1 illustrates LTE, Universal Mobile Telecommunication System (UMTS), and Global System for Mobile Communications (GSM). However, the type of RAT is not limited to these types, but may be arbitrarily selected depending on the make-up of an embodiment. The type of RAT may further include wireless LAN. Accordingly, the mobile terminal may include not only a so-called cellular phone but also a mobile terminal having a cellular phone function and a wireless LAN terminal function (a so-called smart phone).

Here, in FIG. 1, a cell which is formed by a LTE base station (a LTE cell) is depicted by a solid line. Further, a cell which is formed by a UMTS base station (a UMTS cell) is depicted by a dashed line. Furthermore, a cell which is formed by a GSM base station of a (a GSM cell) is depicted by a dashed-dotted line.

In this embodiment, it is assumed that LTE, UMTS, and GSM are RATs that enable high-speed communication and consume a large amount of power in descending order of speed and power consumption. That is, in the LTE cell of the, the mobile terminal 1 is capable of performing high-speed communication, while the mobile terminal 1 consumes a large amount of power. However, in the GSM cell of the, the mobile terminal 1 is capable of suppressing power consumption, but the communication speed of the mobile terminal 1 is lower than for LTE.

The mobile terminal 1 further includes a control device which permits setting of a parameter, for power-saving, which is used for processing to connect to one of a plurality of cells, by using a cell selection data pattern which is selected from the above-described cell selection data patterns, and selects a cell which is to be used for communication, by applying the value of the parameter which is set.

Here, selection of a cell to be executed includes at least one of cell reselection in which the serving cell during standby is re-set, hand-over in which the serving cell is changed during communication, and cell search when transitioning to the outside of a service area. In this embodiment, a case in which selection of a cell to be executed includes all of cell reselection, hand-over, and cell search is described.

Further, in this embodiment, there is a case where cell reselection and hand-over occur even when the mobile terminal 1 does not move. FIG. 1 illustrates a case in which a serving cell of the mobile terminal 1 is shifted from a LTE cell to a UMTS cell due to cell reselection or hand-over in a state where the mobile terminal 1 is not moving.

Thus, in the mobile terminal 1 according to the present embodiment, a parameter related to selection of a cell is set by using a cell selection data pattern which is selected from a plurality of cell selection data patterns corresponding to combinations of a remaining battery amount and an available function. Then, the value of the parameter is applied so as to select a cell which is to be used for communication. At this point, a cell selection data pattern, which allows for reduction in power consumption of the mobile terminal 1, is selected by means of cell selection, that is, change of the cell which is a connection destination of the mobile terminal 1.

Therefore, according to the present embodiment, with a mobile terminal which is capable of standby and communication in cells of a plurality of different RATs, it is possible to select a cell of an appropriate RAT that aims to reduce power consumption and the like with consideration to remaining battery amount and the operating state of the mobile terminal, which includes available functionality.

The storage device included in the mobile terminal 1 may be configured to store cell selection data patterns for enabling processing to connect to a target cell of which power consumption is lower than that of a serving cell, depending on current remaining battery amount and functionality being used. Accordingly, it is possible to obtain a power-saving effect in accordance with the remaining battery amount and the operating state of the functionality of the mobile terminal.

Further, the mobile terminal 1 may control whether to select a cell by using a cell selection data pattern, in accordance with a setting made by a user. That is, the mobile terminal 1 may further include a user interface (hereinafter, referred to also as a “UI”) for setting a battery saving function to on or off, where the setting of the user interface may execute a parameter setting that uses a cell selection data pattern. The UI may include various input devices such as a button, a key, and a touch panel. Due to the adoption of this configuration, it is possible to select, using a cell selection data pattern, a cell at timing desired by a user of the mobile terminal 1.

In this embodiment, selecting a cell by using a cell selection data pattern, leads to a power-saving effect. However, the characteristics of the power-saving effect desired by a user may vary depending on the circumstances. For example, for a specific function a user may desire high-speed communication that consumes a large amount of power over low-speed communication that consumes a small amount of power.

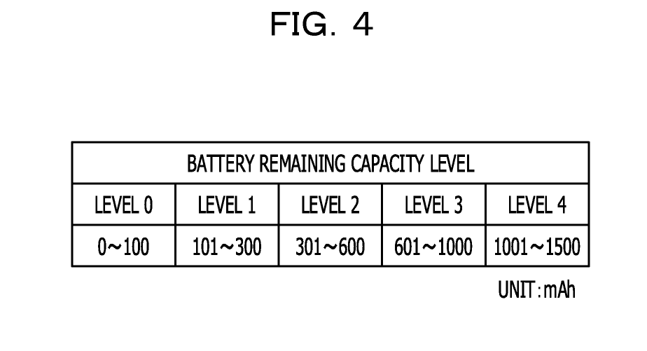

Therefore, the following configuration may be employed for the mobile terminal 1. That is, the storage device of the mobile terminal 1 stores the cell selection data patterns corresponding to a plurality of modes (FIG. 4) which are prepared in response to a plurality of power consumption levels, and the control device performs the parameter setting by using a cell selection data pattern selected from the cell selection data patterns corresponding to a mode which is designated from among the modes.

In other words, the mobile terminal 1 is capable of storing a plurality of cell selection data patterns that correspond to a plurality of modes (referred to as saving modes) that have different power-saving effects. Further, the mobile terminal 1 may be configured so that a cell selection data pattern which is to be used in parameter setting is selected from a plurality of cell selection data patterns which correspond to one of a plurality of saving modes which is set by a user, for example. Accordingly, it becomes possible for a user to set parameters by which a power-saving effect desired by the user is obtained, for the mobile terminal 1. At this point, the user only designates a saving mode by using the UI, for example, thus realizing reduction in power consumption by a simple operation.

[Mobile Terminal]

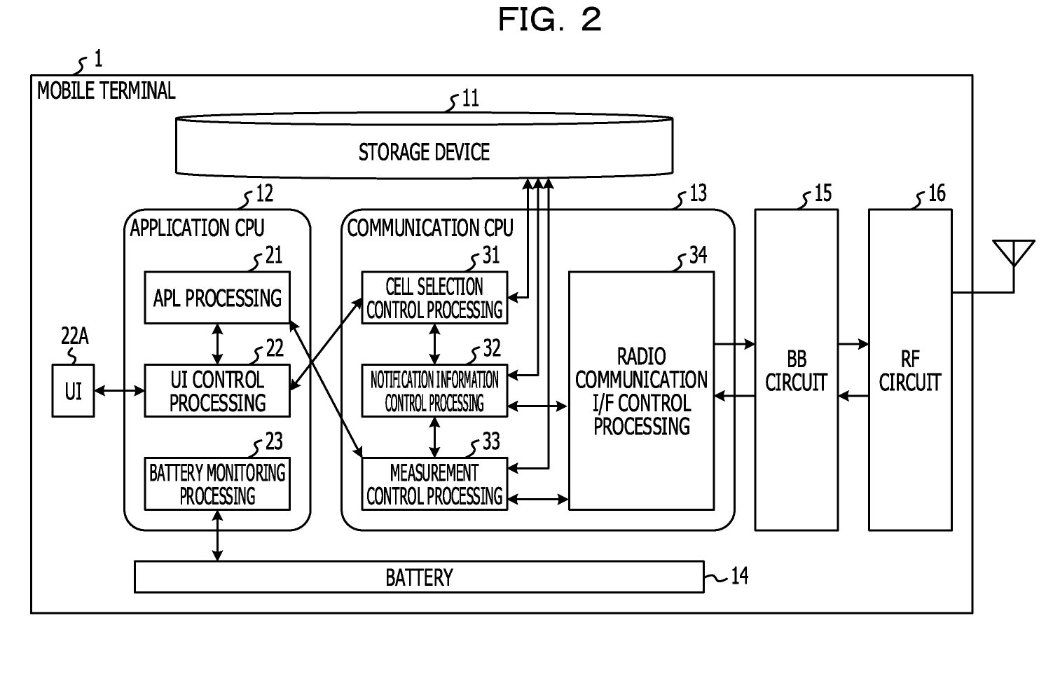

FIG. 2 illustrates the mobile terminal 1 according to the present embodiment. As depicted in FIG. 2, the mobile terminal 1 is a mobile body communication terminal device which includes a storage device 11, an application central processing unit (CPU) 12, a communication CPU 13, a battery 14, a UI 22A, a baseband (BB) circuit 15, and a radio frequency (RF) circuit 16.

Here, regarding the specific configuration of the mobile terminal 1, omission, exchange, and addition of constituent elements may be arbitrarily performed depending on the make-up of an embodiment. For example, the application CPU 12 and the communication CPU 13 may be integrated as one processor or may each include a plurality of processors. The communication CPU 13 is an example of a control device.

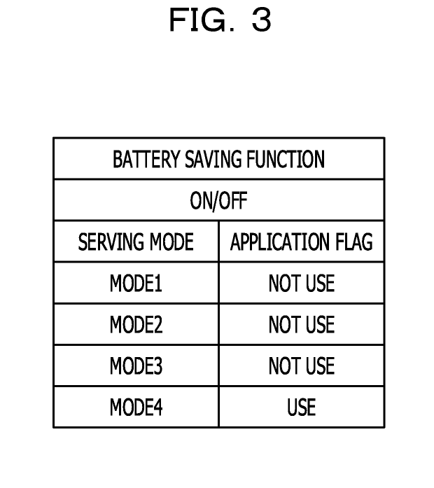

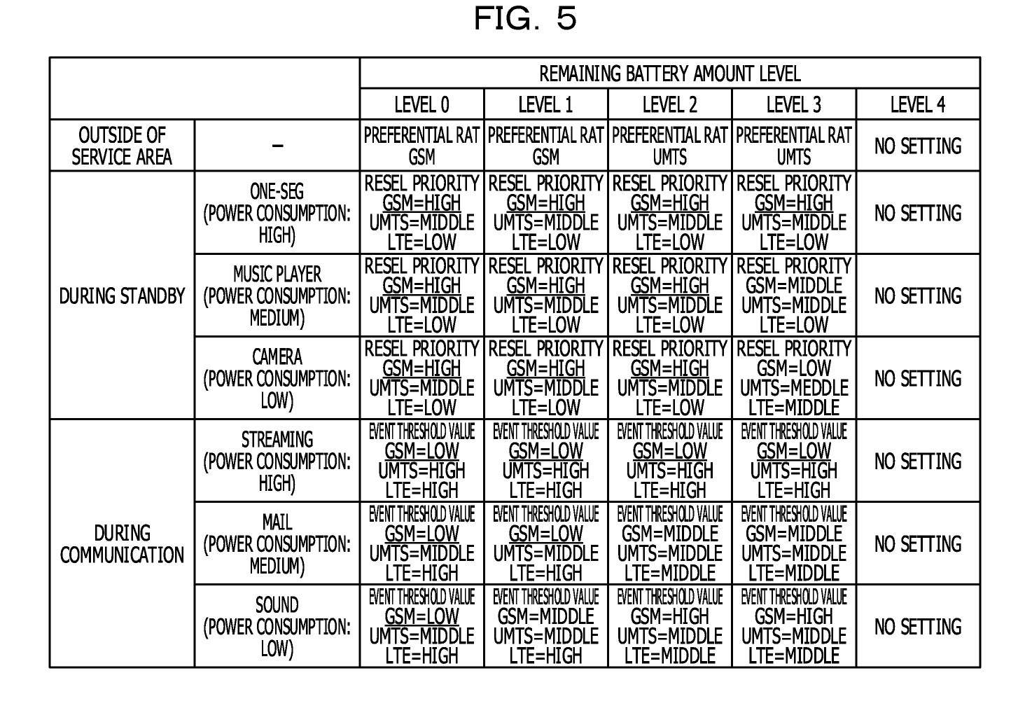

The storage device 11 is a storage device which includes a volatile region and a non-volatile region, such as a ROM, a RAM, an EEPROM, a flash memory, and a hard disk drive, for example. The storage device 11 according to the present embodiment stores saving mode data (FIG. 3) and a plurality of cell selection data tables T (FIG. 5).

FIG. 3 illustrates an example of the data configuration of saving mode data according to the present embodiment. Saving mode data is used to control whether to select a cell by using a cell selection data pattern and to select an expected power-saving effect. In the present embodiment, when a “battery saving function” is “ON” in saving mode data, the mobile terminal 1 selects a cell by using a cell selection data pattern.

Conversely, when the battery saving function is “OFF”, the mobile terminal 1 selects a cell by using a normal operation. For example, the mobile terminal 1 applies a value designated in notification information from the base station to be a parameter used in cell reselection. Further, the mobile terminal 1 applies a value designated by a signal of an individual channel from the base station as a parameter used in a measurement report, for example.

Further, saving mode data is used to specify which cell selection data pattern is used from among a plurality of cell selection data patterns. In the present embodiment, a cell selection data pattern is used in the selection of a cell, enabling a power-saving effect in the mobile terminal 1 to be obtained. In the mobile terminal 1, an operation mode which brings about a power-saving effect through the use of a cell selection data pattern is referred to as a saving mode.

As described above, in the present embodiment a plurality of cell selection data patterns are prepared so as to be able to correspond to a variety of user demands with respect to the characteristics of the power-saving effect. In other words, a plurality of cell selection data patterns are prepared depending on the type of a saving mode.

Here, the type and the number of saving modes are arbitrarily set depending on the make-up of an embodiment. For example, for a specific function, there may be provided a saving mode which is set so that a cell of a high-speed RAT which involves high power consumption instead of a cell of a low-speed RAT which involves low power consumption. Further, saving modes may be set in stages in accordance with a difference of power-saving effects.

In the present embodiment, saving modes in four stages are provided as an example of setting saving modes in stages in accordance with a difference of power-saving effects. In the example illustrated in FIG. 3, “Mode 1” is a saving mode exhibiting the highest power-saving effect and “Mode 4” is a saving mode exhibiting the lowest power-saving effect. In FIG. 3, “Mode 4” is selected.

The mobile terminal 1 selects a cell by using one of a plurality of cell selection data patterns which each correspond to a saving mode, so as to obtain a power-saving effect corresponding to the saving mode. Here, for a cell selection data pattern that brings a higher power-saving effect than other cell selection data patterns, the value of a parameter related to cell selection is set so that a cell of a low-speed (low power consumption) RAT is more frequently selected compared to other cell selection data patterns, for example.

It is possible for a user to set whether to use a battery saving function via the UI 22A of the mobile terminal 1. Further, when the use of the battery saving function is set, it is possible for a user to further select a saving mode to be used via the UI of the mobile terminal 1.

Saving mode data is updated through the following operations. FIG. 3 illustrates a state of saving mode data when a user sets the use of the battery saving mode and selects “Mode 4” as the saving mode to be used. Here, for saving mode data, a saving mode which is used in a default state (a saving mode in initial setting) may be set in advance.

Further, the storage device 11 stores a plurality of cell selection data patterns which each correspond to a combination of remaining battery amount and an available function. For example, the cell selection data table T according to the present embodiment manages a plurality of cell selection data patterns which each correspond to a remaining battery amount level and a state of the mobile terminal 1 from among outside a service area, during standby, and during communication.

FIG. 4 illustrates an example of correlation between battery amount and a remaining battery amount level according to the present embodiment. In the present embodiment, remaining battery amount levels of five stages (Levels 0 to 4) corresponding to certain battery amounts are set. Here, correlation (the number of levels) illustrated in FIG. 4 is merely an example, and correlation between battery amount and a remaining battery amount level may be arbitrarily set depending on the make-up of an embodiment.

FIG. 5 illustrates the data configuration of the cell selection data table T according to the present embodiment. The cell selection data table T illustrated in FIG. 5 stores information about RATs that are given priority in cell search when outside of a service area (preferred RATs for cell search), a plurality of cell selection data patterns for managing the value of cell reselection priority during standby (cell reselection priority), and a plurality of cell selection data patterns for managing the value of an event threshold value which is a trigger of a measurement report. Here, in FIG. 5, cell reselection priority is denoted as “Resel Priority”.

In the cell selection data table T depicted in FIG. 5, a mobile television function (mobile television viewing function), a music player function, and a camera function are illustrated as functions (including services) that are available during standby. Further, in the present embodiment, it is assumed that the mobile television function, the music player function, and the camera function consume a large amount of power in a descending order of the mobile television function, the music player function, and the camera function.

Further, in the cell selection data table T depicted in FIG. 5, a streaming function, a mail function, and a voice function (voice call (speech) function) are illustrated as functions (including services) that are available during communication. In the present embodiment, it is assumed that the streaming function, the mail function, and the voice function consume a large amount of power in a descending order of the streaming function, the mail function, and the voice function.

In the cell selection data table T depicted in FIG. 5, as the remaining battery amount level decreases when outside of a service area a low-speed RAT that involves low power consumption is more likely to become a cell search target. In a state outside a service area, the control device (the communication CPU 13) searches for a cell of a RAT which is a cell search target, and cell search for other RATs is restricted. Commonly, when outside of a service area, the mobile terminal 1 searches the whole range of frequencies related to a cell of an available RAT. Therefore, as the number of types of RATs available in a mobile terminal is larger, a larger amount of power is consumed.

In the present embodiment, the RAT for which a cell is searched for when outside of a service area is determined from among available RATs based on the table T in accordance with the storage content of the cell selection data table T, and cell search for other RATs is restricted. Accordingly, the mobile terminal 1 does not have to evenly search cells for all available RATs, and is able to narrow the search range. Consequently, reduction in power consumption may be achieved.

Further, the cell selection data table T depicted in FIG. 5 has a setting wherein during standby and during communication a cell of a low-speed RAT that involves low power consumption is preferentially selected when a function used has high power consumption and the remaining battery amount level is low. This is because it is conceivable that a power-saving effect is commonly demanded when a function used has high power consumption and the remaining battery amount level is low.

The cell selection data table T depicted in FIG. 5 stores a plurality of cell selection data patterns which correspond to functions available during standby and during communication. Each cell data pattern includes a plurality of cell selection data patterns that correspond to remaining battery amount levels. A cell selection data pattern is a record which is specified by a remaining battery amount level and a function used, and holds a value to be applied as a parameter related to selection of a cell. By setting a value by which a cell of a low-speed RAT that involves low power consumption is selected in a large number of records, a cell selection data table T exhibiting a superior power-saving effect is able to be created.

Here, cell reselection priority combined with an event threshold value are an example of a parameter which is related to selection of a cell and is defined in the 3rd Generation Partnership Project (3GPP). Parameters related to selection of a cell are not limited to these parameters but may be arbitrarily selected depending on the make-up of an embodiment.

Here, the content of a parameter defined in 3GPP varies for each RAT. Therefore, the cell selection data table T is prepared for each available RAT. Further, the cell selection data table T is prepared for each saving mode described above. The cell selection data table T depicted in FIG. 5 illustrates a situation where the mobile terminal 1 is in an LTE cell and the saving mode is “Mode 4”. A plurality of cell selection data tables T are stored in a non-volatile region of the storage device 11 in a non-editable manner.

That is, the storage device 11 stores in the cell selection data table T with a number of entries equal to the number of saving modes multiplied by the number of types of RATs for available cells. For example, in the present embodiment, four types of saving modes and three types of RATs are illustrated, so that the storage device 11 stores at least twelve entries in the cell selection data table T. Here, FIG. 5 has been used to illustrate an example in which a function is alternatively selected. When a plurality of functions may be used simultaneously, a cell selection data pattern for a combination of functions which are simultaneously used is stored in the table T.

In the present embodiment, when the battery saving function is “OFF”, either the value of a parameter of cell reselection which is designated by notification information from the base station or the value of a parameter of a measurement report which is designated by a signal of an individual channel from the base station is used in a similar manner to the related art.

Conversely, when the battery saving function is “ON”, the value of a parameter which is managed in a cell selection data pattern is applied to control of cell (re)selection and a measurement report. Further, cell search when transitioning to outside of a service area is performed in accordance with a preferred RAT which is managed by using a cell selection data pattern.

Referring back to FIG. 2, the application CPU 12 executes a program which is stored in the storage device 11 to thereby execute application (APL) processing 21, UI control processing 22, and battery monitoring processing 23 which are related to a battery saving setting. That is, the application CPU 12 realizes a battery saving function by means of the APL processing 21, a function as a UI controller by means of the UI control processing 22, and a remaining battery amount level detecting function by means of the battery monitoring processing 23. The APL processing 21 is realized by executing an application program related to a battery saving setting.

Further, the communication CPU 13 executes a program stored in the storage device 11 to thereby execute cell selection control processing 31, notification information control processing 32, measurement control processing 33, and radio communication interface (I/F) control processing 34. That is, the communication CPU 13 functions as a cell selection controller by means of the cell selection control processing 31, a notification information controller by means of the notification information control processing 32, a measurement controller by means of the measurement control processing 33, and a communication I/F controller by means of the radio communication I/F control processing 34. Here, all or a part of a plurality of above-described processing (a plurality of functions) which are executed in the application CPU 12 and the communication CPU 13 may be realized by a hardware logic circuit.

In the battery monitoring processing 23, the remaining amount of the battery 14 is detected based on a signal transmitted from a battery sensor which is not depicted. Further, in the radio communication I/F control processing 34, transmission and reception of data with respect to an antenna is performed via the BB circuit 15 and the RF circuit 16.

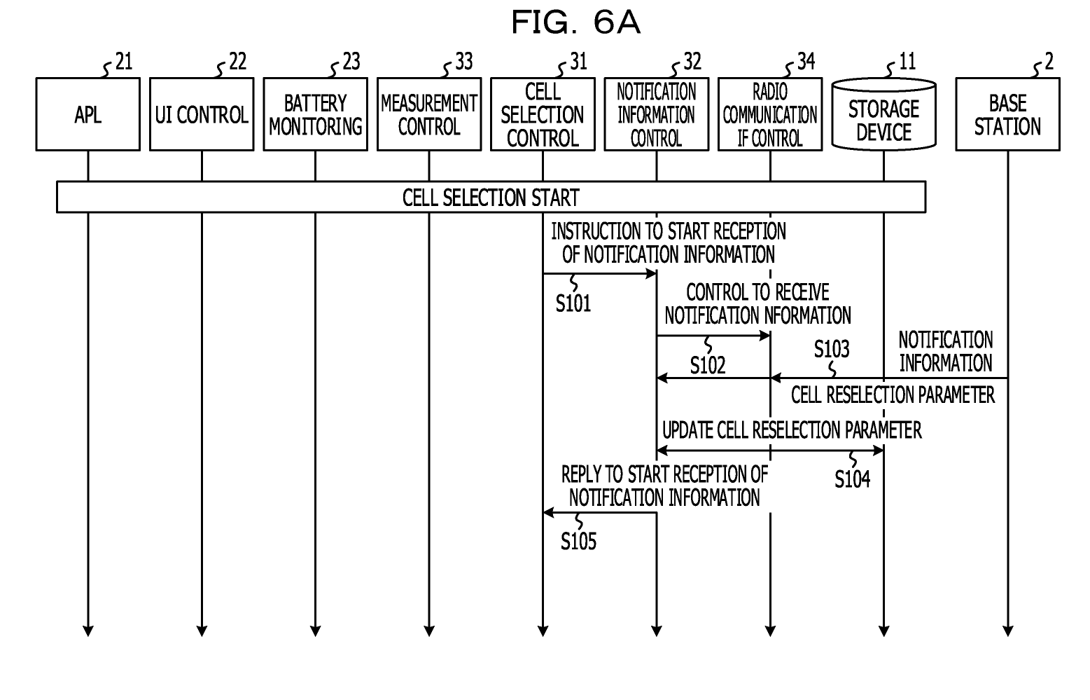

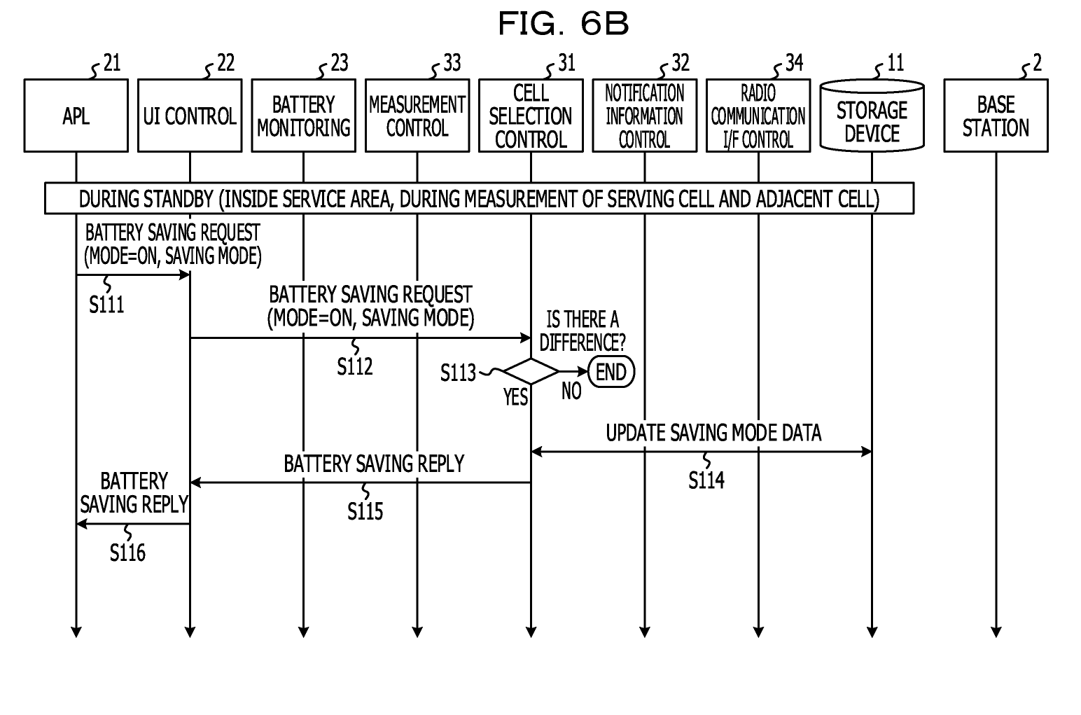

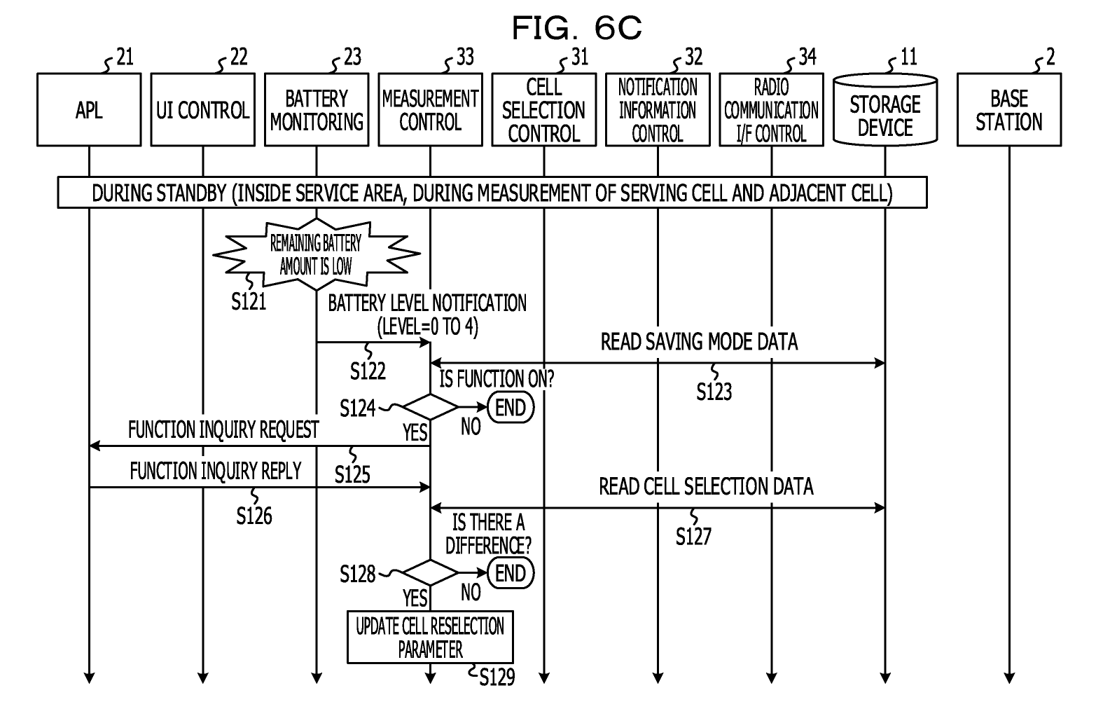

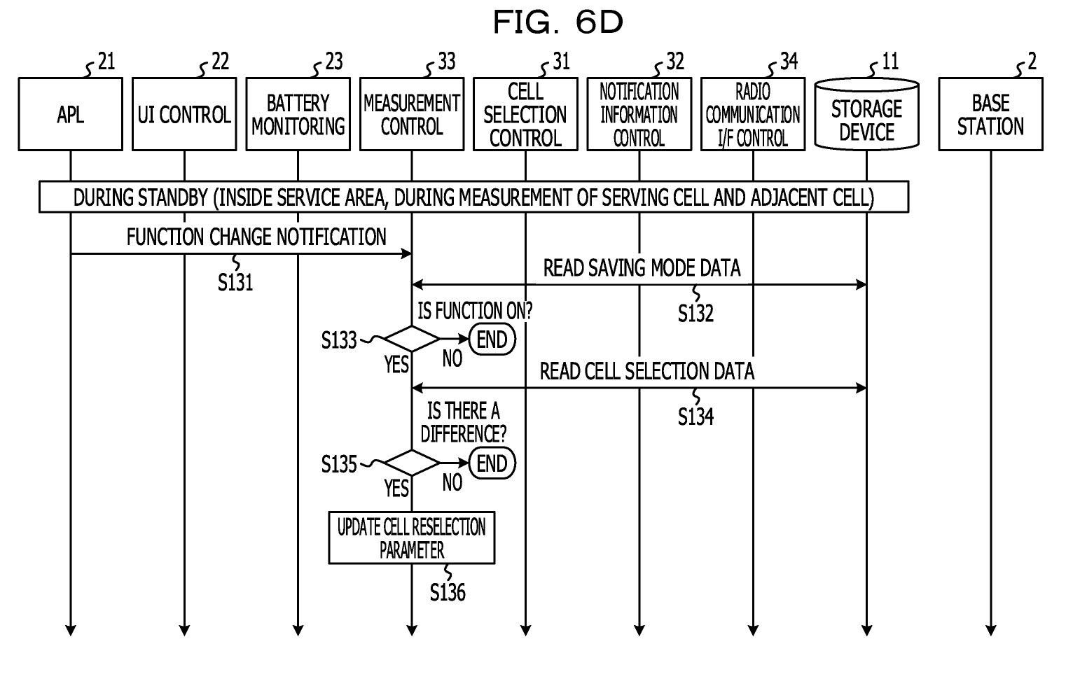

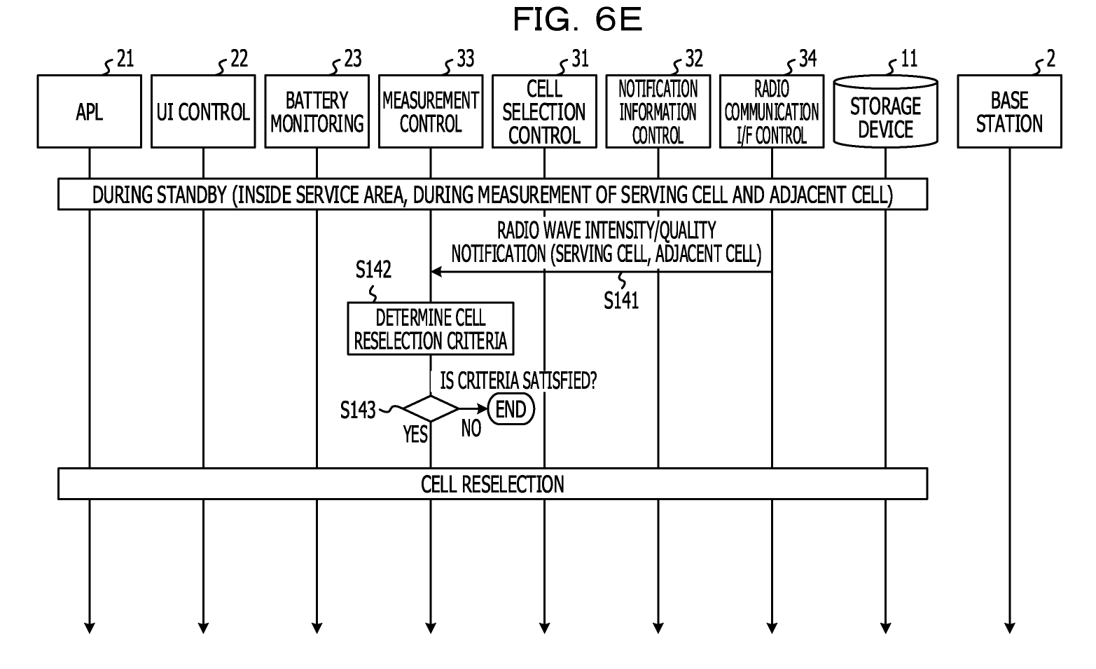

FIGS. 6A to 6E are sequence diagrams illustrating the relation among processing of the mobile terminal 1 that relates to cell selection or cell reselection.

Here, each processing procedure described below is merely an example, and processing may be switched wherever possible when there is no dependency relation such as a when using a result of processing which is executed before the current processing. Further, processing may be omitted where possible and may be replaced with different processing.

FIG. 6A illustrates processing of the application CPU 12 and the communication CPU 13 of the mobile terminal 1 which have started cell selection. Firstly, the cell selection control processing 31 instructs the notification information control processing 32 to start reception of notification information to be transmitted from a base station 2 (S101).

In the notification information control processing 32, the radio communication I/F control processing 34 is executed so as to receive notification information, in response to the above instruction (S102). In the present state, when the notification information is transmitted from the base station 2 (S103), the notification information control processing 32 receives the notification information via the radio communication I/F control processing 34.

In the notification information control processing 32, the value of a cell reselection parameter is acquired from the notification information which has been received, and the acquired value of the cell reselection parameter is stored in the storage device 11 (S104). Then, when the above processing is complete, the notification information control processing 32 provides a reply to the cell selection control processing 31 indicating that the notification information has been received (S105).

FIG. 6B is a sequence diagram illustrating an operation of a case in which a user changes the configuration related to a battery saving function via a user interface of the mobile terminal 1 while the mobile terminal 1 is in a standby state and is performing processing to measure a serving cell and an adjacent cell.

The APL processing 21 related to the battery saving function requests configuration change of a battery saving mode from the UI control processing 22 in response to an operation of the UI 22A of the mobile terminal 1 (S111). The UI control processing 22 requests configuration change of a battery saving mode from the cell selection control processing 31 based on the details of an operation of the UI (S112).

The cell selection control processing 31 compares the details of a change specified by the details of the operation of the UI which has been received from the UI control processing 22 with the details of saving mode data so as to determine whether there is a difference (S113). When there is no difference, the processing ends. Conversely, when there is a difference, the cell selection control processing 31 updates the details of the saving mode data, which is stored in the storage device 11, in accordance with the details of the change (S114).

Then, the cell selection control processing 31 provides a reply to the UI control processing 22 indicating that the requested update has completed (S115). Upon receiving the reply, the UI control processing 22 provides a similar reply to the APL processing 21 (S116). Accordingly, the update of the saving mode data completes.

When the battery saving function is OFF in S111 of FIG. 6B, a battery saving request designating an initially-set saving mode in which the battery saving function is “OFF” is transmitted (issued). Conversely, when the battery saving function is ON, a battery saving request designating a changed saving mode in which the battery saving function is “ON” is transmitted (issued).

Then, in S113, the saving mode included in the battery saving request is compared with a saving mode which is held in the cell selection control processing 31. When these saving modes are different from each other, saving mode data updating processing to change the saving mode included in the battery saving request is performed.

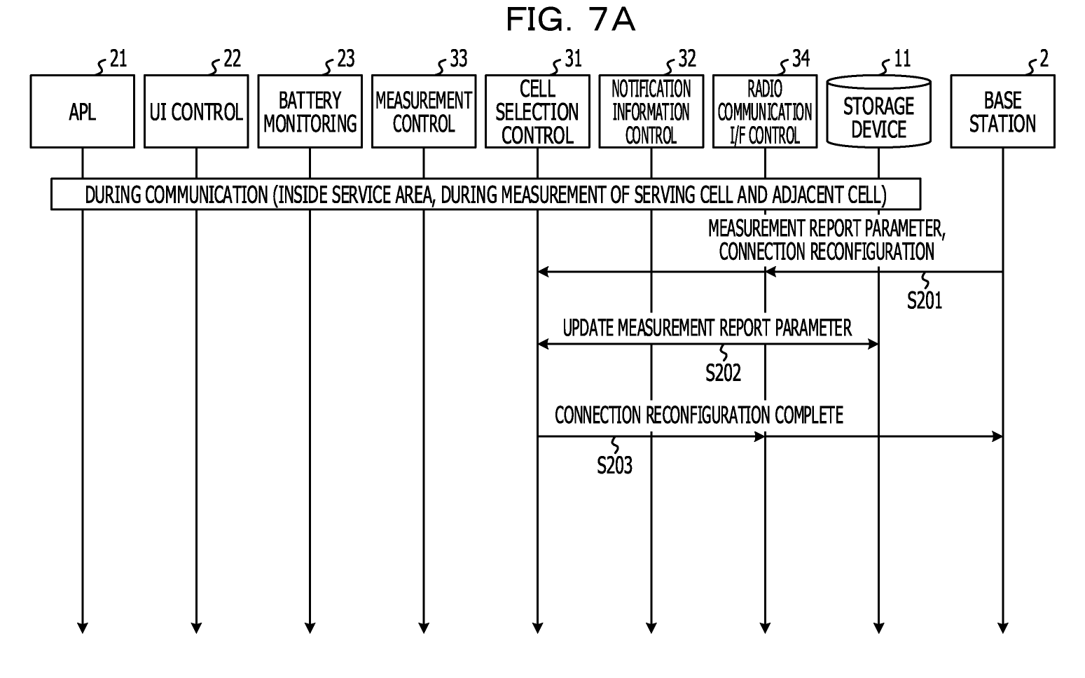

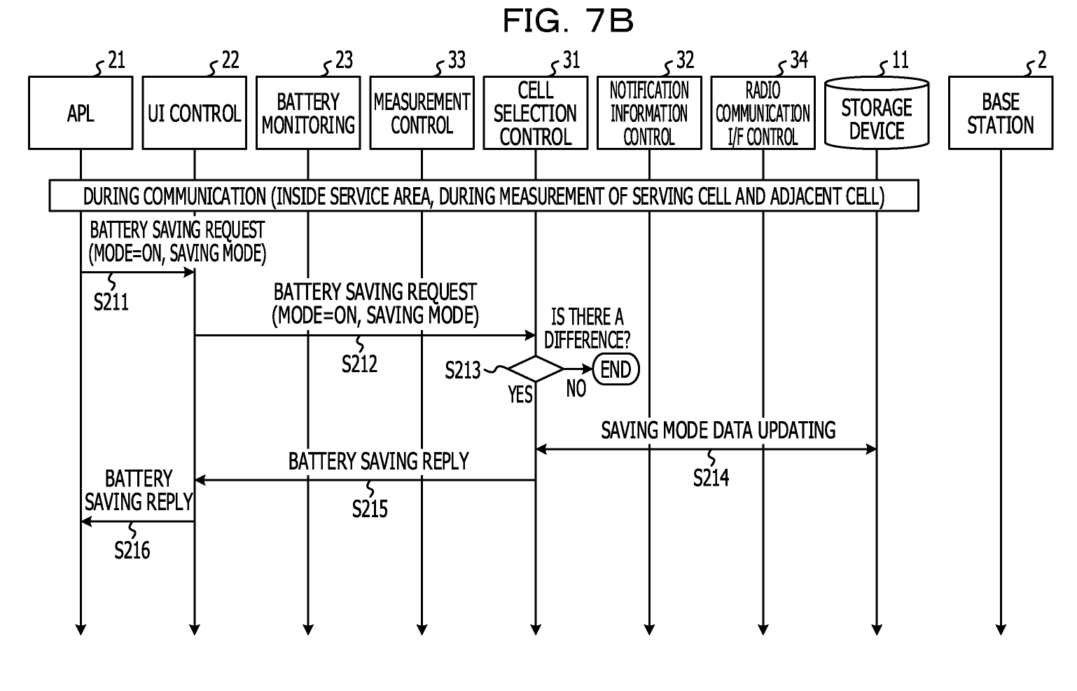

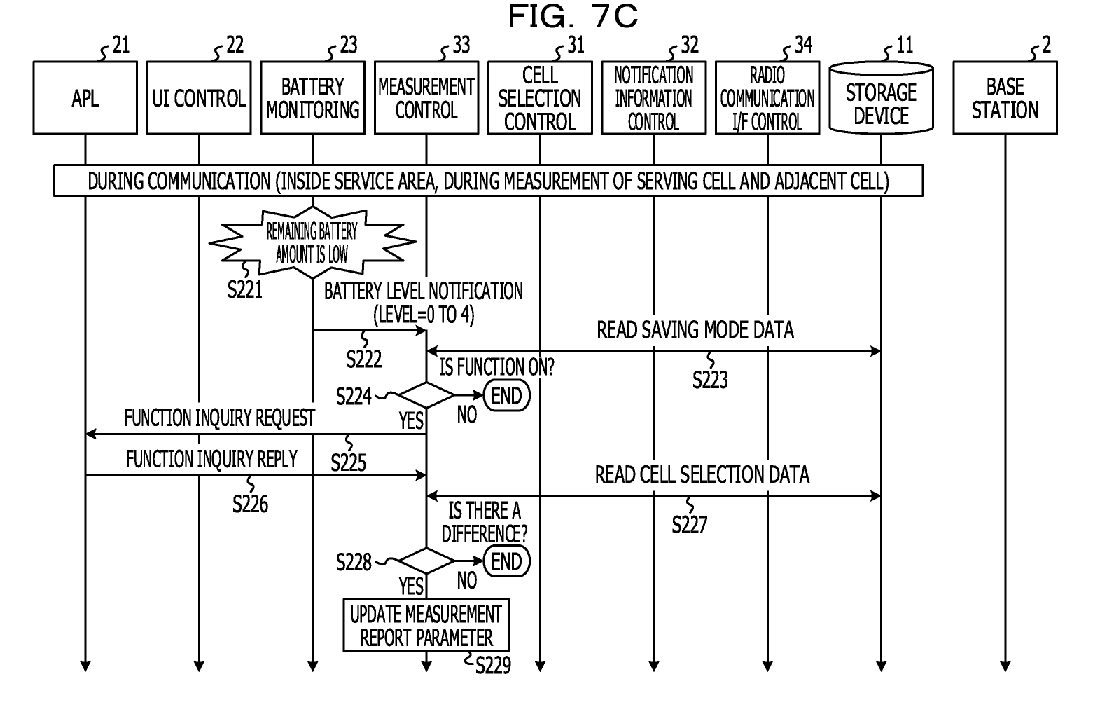

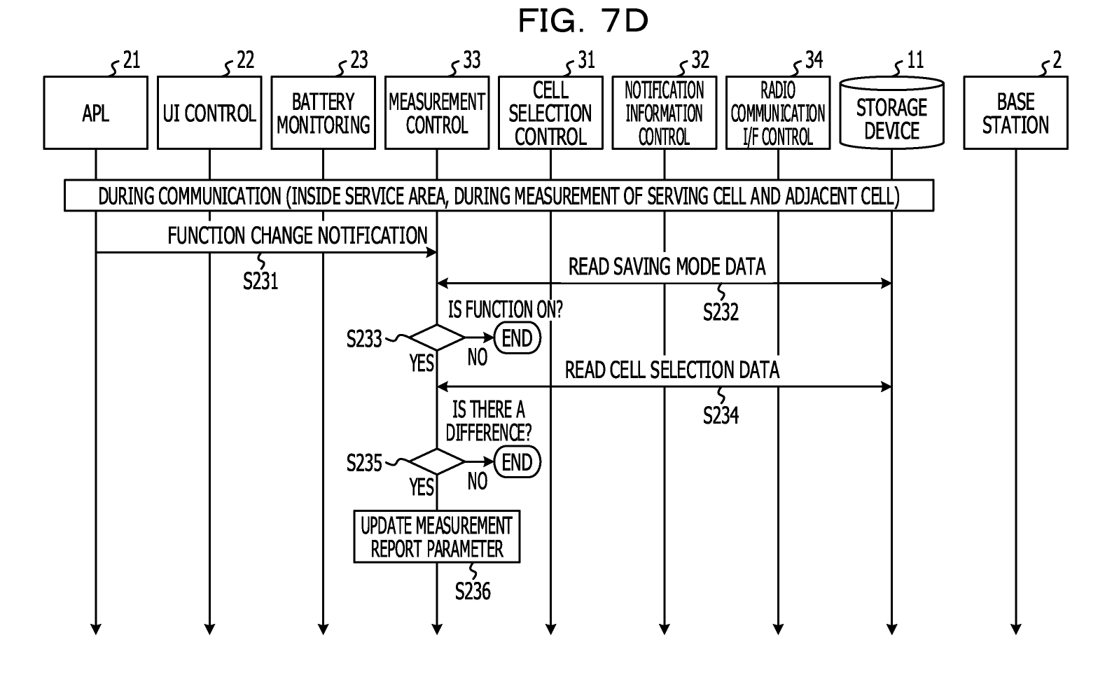

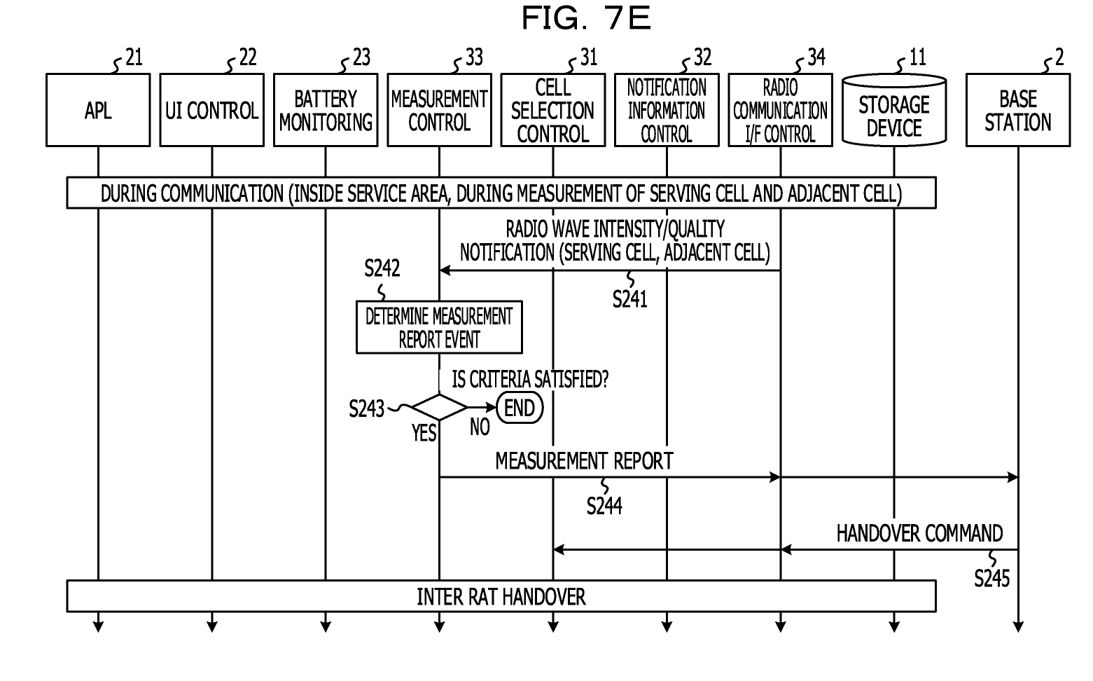

FIG. 6C is a sequence diagram illustrating processing of a case where the remaining battery amount of the mobile terminal 1 fluctuates while the mobile terminal 1 is in a standby state and measures a serving cell and an adjustment cell. FIG. 6C illustrates a case in which remaining battery amount has decreased. Processing similar to that of FIG. 6C is also performed when the remaining battery amount has increased (the same applies for later-described processing of FIG. 7C).

As depicted in FIG. 6C, when the remaining amount level of the battery 14 fluctuates during standby, the communication CPU 13 of the mobile terminal 1 executes processing to select a cell selection data pattern which is used for parameter setting in accordance with the currently-used function.

That is, when the remaining amount of the battery 14 has decreased (S121), the battery monitoring processing 23 notifies the measurement control processing 33 of the current remaining amount level of the battery 14 (S122). Specifically, the battery monitoring processing 23 specifies a remaining battery amount level to which the current remaining battery amount belongs and notifies the measurement control processing 33 of the specified remaining battery amount level.

The measurement control processing 33 reads saving mode data in response to the notification (S123), and determines whether the battery saving function is “ON” (S124). When the battery saving function is not “ON”, the processing ends.

Conversely, when the battery saving function is “ON”, the measurement control processing 33 inquires about the currently-operating function (including a service) from the APL processing 21 (S125). In response to this inquiry, the APL processing 21 returns the currently-operating function to the measurement control processing 33 (S126).

The measurement control processing 33 reads a cell selection data table T that corresponds to both the type of a RAT for a cell in which the mobile terminal 1 is present and a saving mode which is designated in saving mode data, from the storage device 11 (S127). Then, the measurement control processing 33 refers to a record, in the cell selection data table T which is read, that corresponds to the remaining battery amount level which is notified in S122 and the currently-operating function which is notified in S126.

The measurement control processing 33 acquires the value of a parameter related to selection of a cell from the record which is referred and determines whether there is a difference between the value of an in-use parameter and the acquired value (S128). When there is no difference, the processing ends. Conversely, when there is a difference, the measurement control processing 33 changes (updates) the value of a parameter which is used for selection of a cell to the value which is acquired from the record (a cell selection data pattern) referenced in the cell selection data table T (S129).

In S129, the value of cell reselection priority, a parameter of cell reselection, is updated. However, even when the corresponding value is updated, the storage device 11 continues to hold the value of a parameter of the cell reselection acquired from notification information for when the battery saving function becomes “OFF”. Accordingly, updating of a cell reselection parameter ends. Here, notification of S122 may be executed only when the remaining battery amount level is changed (lowered) due to decrease of remaining battery amount. Further, the measurement control processing 33 may hold the last remaining battery amount level notified in S122 and perform processing S123 and thereafter only when the remaining battery amount level received through new notification is different from the held remaining battery amount level. These modifications are applicable to later-described processing illustrated in FIG. 7C as well.

FIG. 6D is a sequence diagram illustrating an operation of a case where a function executed in the mobile terminal 1 is changed while the mobile terminal 1 is in a standby state and is measuring a serving cell and an adjacent cell.

As depicted in FIG. 6D, during standby and when the function which is used in the mobile terminal 1 is changed, the communication CPU 13 of the mobile terminal 1 performs processing to select a cell selection data pattern which is used for parameter setting, in accordance with the function that has changed.

That is, when the operating function changes due to an operation of a user with respect to the UI 22A of the mobile terminal 1, the APL processing 21 notifies the measurement control processing 33 of the change of the function (S131). The APL processing 21 sends notice of the function that has changed, in the notification.

In response to the notification, the measurement control processing 33 reads saving mode data (S132), and determines whether there is a saving mode in which the battery saving function is “ON” (S133). When the battery saving function is not “ON” (when there is no saving mode which is “ON”), the processing ends.

Conversely, when the battery saving function is “ON”, the measurement control processing 33 reads from the storage device 11 a cell selection data table T that corresponds to the type of a RAT for a cell in which the mobile terminal 1 is present, the saving mode which is designated in the saving mode data, and the function that has changed (S134).

Then, the measurement control processing 33 refers to a record (a cell selection data pattern), in the read cell selection data table T, that corresponds to the remaining battery amount level already notified by the battery monitoring processing 23 and the currently-operating function notified in S131. When the measurement control processing 33 is not notified of the remaining battery amount level by the battery monitoring processing 23, the measurement control processing 33 inquires about the remaining amount level of the battery 14 from the battery monitoring processing 23 so as to grasp the remaining battery amount level.

The measurement control processing 33 acquires the value of a parameter related to selection of a cell from the record which is referenced and determines whether there is a difference between the value of a currently-used parameter and the acquired value (S135). When there is no difference, the processing ends. Conversely, when there is a difference, the measurement control processing 33 changes (updates) the value of a parameter which is used for selection of a cell to the value which is acquired from the record (a cell selection data pattern) referred to in the cell selection data table T (S136).

In S136, the value of a cell reselection priority is updated from amongst cell reselection parameters, as is the case with S129. However, even when the corresponding value is updated, in preparation for when the battery saving function becomes “OFF”, the storage device 11 continues to hold the value of a parameter of the cell reselection which is acquired from notification information. Accordingly, update of a cell reselection parameter is completed.

FIG. 6D illustrates processing of a case in which switching of the mobile television function, the sound/video reproduction function, and the camera function which are illustrated in FIG. 5 is performed as function change in the mobile terminal 1 which is in a standby state. Conversely, when the currently-used function is stopped, notification of the function stop is sent in S131. All pieces of saving mode data which are read in S132 are turned OFF to turn OFF (release) the battery saving function, thereby allowing the processing to end.

Alternatively, in a case where a cell selection data pattern which is applied when all of a plurality of functions available during standby become to be in a stop state (total stop state) is stored in advance in the cell selection data table T (FIG. 5), and when a total stop state is caused by stop of functions, parameter updating based on the corresponding cell selection data pattern may be executed.

Alternatively, when the total stop state is brought about by the stop of functions, the state before the stop may be maintained and the processing of S131 may be executed in subsequent start-up of any function. These modifications are applicable to later-described processing of FIG. 7D in a similar manner.

FIG. 6E illustrates an operation related to cell reselection which is executed in the mobile terminal 1 while the mobile terminal 1 is in a standby state and measures a serving cell and an adjacent cell.

The measurement control processing 33 acquires information about the radio field intensity and quality of a serving cell and an adjacent cell, via the radio communication I/F control processing 34 (S141). Then, the measurement control processing 33 determines whether criteria of cell reselection are satisfied, by using a cell reselection parameter and the acquired information (S142, S143). When the criteria of cell reselection are not satisfied, the processing ends. Conversely, when the criteria of cell reselection are satisfied, cell reselection is executed.

In the present embodiment, when the remaining battery amount is lowered as illustrated in FIG. 6C or when the currently-operating function is changed as illustrated in FIG. 6D before the execution of S142, to determine cell reselection a value which is set in a cell selection data pattern is used. Accordingly, a power-saving effect may be obtained in the present embodiment.

FIGS. 7A to 7E illustrate processing, as related to hand-over, of the application CPU 12 and the communication CPU 13 of the mobile terminal 1. Operations illustrated in FIGS. 7A to 7E are almost same as operations and processing illustrated in FIGS. 6A to 6E, except for where cell reselection during standby is changed into hand-over during communication.

FIG. 7A illustrates an operation of a case in which a message about connection reconfiguration is sent from the base station 2 while the mobile terminal 1, while communicating, measures a serving cell and an adjacent cell.

The cell selection control processing 31 acquires a message about connection reconfiguration from the base station 2 via the radio communication I/F control processing 34 (S201). The message includes the value of a parameter related to a measurement report.

The cell selection control processing 31 updates the value, which is acquired from the base station 2 and is already stored in the storage device 11, of a parameter related to a measurement report to be the value acquired in S201 (S202). Then, the cell selection control processing 31 provides a reply indicating completion of processing related to connection reconfiguration to the base station 2 via the radio communication I/F control processing 34 (S203).

FIG. 7B is a sequence diagram illustrating an operation of a case in which a user has changed configuration related to a battery saving function via a UI of the mobile terminal 1 while the mobile terminal 1 is communicating and is performing processing to measure a serving cell and an adjacent cell.

In response to an operation of the UI of the mobile terminal 1, the APL processing 21 requests the UI control processing 22 to make a configuration change to the battery saving mode (S211). Based on the operation content of the user interface, the UI control processing 22 requests configuration change of the battery saving mode from the cell selection control processing 31 (S212).

The cell selection control processing 31 compares the details of the change specified by the details of the operation from the user interface, which is received from the UI control processing 22, with the details of saving mode data so as to determine whether there is a difference (S213). When there is no difference, the processing ends. Conversely, when there is a difference, the cell selection control processing 31 updates the details of the saving mode data which is stored in the storage device 11 in accordance with the details of the change (S214).

Then, the cell selection control processing 31 provides a reply indicating the completion of the requested update to the UI control processing 22 (S215). Upon receiving the reply, the UI control processing 22 provides a similar reply to the APL processing 21 (S216). Accordingly, the update of the saving mode data is completed.

FIG. 7C is a sequence diagram illustrating the operation of a case in which the remaining battery amount of the mobile terminal 1 has decreased while the mobile terminal 1 is communicating and is measuring a serving cell and an adjustment cell.

In FIG. 7C, when the remaining amount level of the battery 14 has decreased during communication, the communication CPU 13 of the mobile terminal 1 performs processing to select a cell selection data pattern which is used for parameter setting in accordance with the currently-used function. That is, when the remaining amount of the battery 14 decreases (S221), the battery monitoring processing 23 notifies the measurement control processing 33 of the remaining amount level of the battery 14 (S222). Specifically, the battery monitoring processing 23 notifies the measurement control processing 33 of the remaining battery amount level to which the current battery amount belongs.

The measurement control processing 33 reads saving mode data in response to the notification (S223), and determines whether the battery saving function is “ON” (S224). When the battery saving function is not “ON”, the processing ends.

Conversely, when the battery saving function is “ON”, the measurement control processing 33 asks the APL processing 21 about the currently-operating function (S225). In response to this inquiry, the APL processing 21 returns the currently-operating function to the measurement control processing 33 (S226).

The measurement control processing 33 reads a cell selection data table T that corresponds to the type of the RAT for a cell in which the mobile terminal 1 is present and the saving mode which is designated by saving mode data, from the storage device 11 (S227). Then, the measurement control processing 33 refers to a record (a cell selection data pattern), in the read cell selection data table T, corresponding to the remaining battery amount level notified in S222 and the currently-operating function notified in S226.

The measurement control processing 33 acquires the value of a parameter related to selection of a cell from the record which is referred to and determines whether there is a difference between the value of an in-use parameter and the acquired value (S228). When there is no difference, the processing ends. Conversely, when there is a difference, the measurement control processing 33 changes (updates) the value of the parameter used for selection of a cell to the value which is acquired from the record (the cell selection data pattern) referred to in the cell selection data table T (S229).

In S229, from among parameters related to the measurement report, the value of an event threshold value which is a trigger of a measurement report is updated. However, even after the corresponding value is updated, the storage device 11 continues to hold the value of a parameter related to the measurement report which is acquired from the base station 2 in case the battery saving function becomes “OFF”. Accordingly, processing related to updating ends.

FIG. 7D is a sequence diagram illustrating the operation of a case in which a function executed in the mobile terminal 1 is changed while the mobile terminal 1 is communicating and is measuring a serving cell and an adjacent cell.

As depicted in FIG. 7D, when the function used in the mobile terminal 1 is changed while the mobile terminal 1 is communicating, processing to select a cell selection data pattern used for parameter setting is executed in accordance with the post-change function. That is, when the operating function is changed due to an operation of a user with respect to the mobile terminal 1, the APL processing 21 notifies the measurement control processing 33 of the change of the function (S231). The APL processing 21 sends notice of the post-change function in the notification.

The measurement control processing 33 reads saving mode data in response to the notification (S232), and determines whether the battery saving function is “ON” (S233). When the battery saving function is not “ON”, the processing ends.

Conversely, when the battery saving function is “ON”, the measurement control processing 33 reads from the storage device 11 a cell selection data table T corresponding to the type of a RAT for a cell in which the mobile terminal 1 is present and a saving mode which is designated in the saving mode data (S234).

Then, the measurement control processing 33 refers to a record in the read cell selection data table T where the record corresponds to a remaining battery amount level, which has been already notified by the battery monitoring processing 23, and the currently-operating function, which is notified in S231. When the measurement control processing 33 is not notified of the remaining battery amount level by the battery monitoring processing 23, the measurement control processing 33 inquires about the remaining amount level of the battery 14 from the battery monitoring processing 23 so as to grasp the remaining battery amount level.

The measurement control processing 33 acquires the value of a parameter related to selection of a cell from the record which is referred to and determines whether there is a difference between the value of a currently-used parameter and the acquired value (S235). When there is no difference, the processing ends.

Conversely, when there is a difference, the measurement control processing 33 changes (updates) the value of a parameter which is used for selection of a cell to the value which is acquired from the record (a cell selection data pattern) referred to in the cell selection data table T (S236).

In S236, the value of an event threshold value which is a trigger of a measurement report is updated out of parameters related to the measurement report, as is the case with S229. However, even when the corresponding value is updated, the storage device 11 continues to hold the value of a parameter related to the measurement report which is acquired from the base station 2 in case the battery saving function becomes “OFF”.

FIG. 7E is a sequence diagram illustrating an operation related to hand-over which is executed in the mobile terminal 1 while the mobile terminal 1 is communicating and is measuring a serving cell and an adjacent cell.

The measurement control processing 33, via the radio communication I/F control processing 34, acquires information about the radio field intensity and quality of a serving cell and an adjacent cell (S241). Then, the measurement control processing 33 determines whether criteria for provision of a measurement report are satisfied, by using a parameter related to the measurement report and the acquired information (S242, S243).

If, before the execution of S242, the remaining battery amount decreases as illustrated in FIG. 7C or when the currently-operating function is changed as illustrated in FIG. 7D, the value which is set in a cell selection data pattern is used in the determination of the measurement report. Accordingly, a power-saving effect may be obtained in the present embodiment.

When the criteria of the measurement report are not satisfied, the processing ends. Conversely, when the criteria of the measurement report are satisfied, the measurement control processing 33 controls the radio communication I/F control processing 34 and provides a measurement report to the base station 2 (S244).

When the base station 2 receives the measurement report, the base station 2 returns a hand-over command to the mobile terminal 1 (S245). When the cell selection control processing 31 receives the command via the radio communication I/F control processing 34, the cell selection control processing 31 executes the hand-over processing.

[Operation Example]

<In Remaining Battery Amount Change>

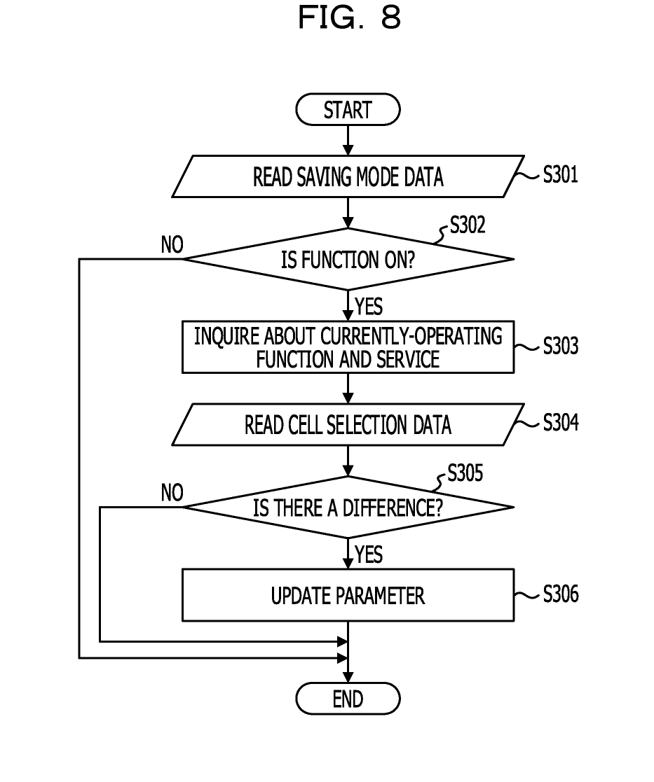

FIG. 8 illustrates an example of processing performed by the application CPU 12 and the communication CPU 13 to update a parameter related to selection of a cell when remaining battery amount has decreased in the mobile terminal 1. The battery monitoring processing 23 monitors the remaining amount of the battery 14. When the level of the remaining amount of the battery 14 decreases, the battery monitoring processing 23 notifies the measurement control processing 33 of the remaining amount level of the battery 14. Accordingly, the operation begins.

In S301, the measurement control processing 33 reads saving mode data from the storage device 11. Then, in S302, the measurement control processing 33 refers to the saving mode data which is read and determines whether the battery saving function is “ON”.

When the battery saving function is not “ON”, the processing ends. Conversely, when the battery saving function is “ON”, the processing goes to S303.

In S303, the measurement control processing 33 inquires about the currently-operating function from the APL processing 21. Accordingly, the measurement control processing 33 grasps the function operating in the mobile terminal 1.

In S304, the measurement control processing 33 reads, from the storage device 11, a cell selection data table T corresponding to the type of a RAT for a cell in which the mobile terminal 1 is present and a saving mode which is designated in the saving mode data. Then, the measurement control processing 33 refers to a record, in the read cell selection data table T, that corresponds to the remaining battery amount level which is notified from the battery monitoring processing 23 and the currently-operating function which is grasped in S303.

In S305, the value of a parameter related to selection of a cell is acquired from the record which is referred to, and whether there is a difference between the value of a currently used parameter and the acquired value is determined. When there is no difference, the processing ends. Conversely, when there is a difference, the measurement control processing 33 changes (updates) the value of a parameter which is used for selection of a cell to the value which is acquired from the referred-to record (a cell selection data pattern) of the cell selection data table T (S306).

In S306, when the mobile terminal 1 is in a standby state, the value of a cell reselection priority is updated among parameters of cell reselection. Conversely, when the mobile terminal 1 is communicating, the value of an event threshold value, which is a trigger of a measurement report, is updated from among parameters related to the measurement report, in S306. Accordingly, the processing related to updating ends.

<In Operation Function Change>

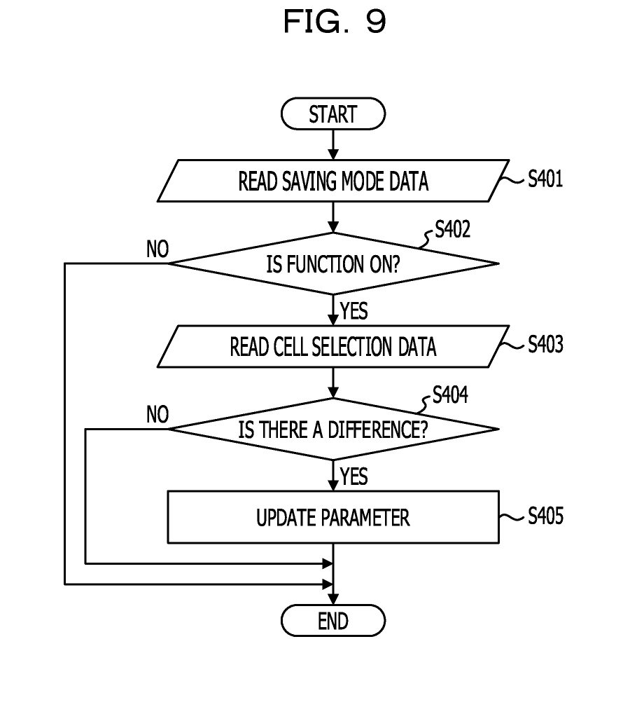

FIG. 9 illustrates an example of processing of the application CPU 12 and the communication CPU 13 related to updating a parameter related to selection of a cell when a function which is used in the mobile terminal 1 is changed. When a function to be operated changes due to an operation of a user with respect to the mobile terminal 1, the APL processing 21 notifies the measurement control processing 33 of the change of the function. Accordingly, the operation begins.

In S401, the measurement control processing 33 reads saving mode data from the storage device 11. Then, in S402, the measurement control processing 33 refers to the saving mode data which is read and determines whether the battery saving function is “ON”.

When the battery saving function is not “ON”, the processing ends. Conversely, when the battery saving function is “ON”, the processing goes to S403.

In S403, the measurement control processing 33 reads, from the storage device 11, a cell selection data table T corresponding to the type of a RAT for a cell in which the mobile terminal 1 is present and a saving mode which is designated in the saving mode data. Then, the measurement control processing 33 refers to a record, in the read cell selection data table T, corresponding to the remaining battery amount level which is already notified from the battery monitoring processing 23 and the currently-operating function which is notified from the APL processing 21.

When the remaining battery amount level is not notified from the battery monitoring processing 23, the measurement control processing 33 inquires about the remaining amount level of the battery 14 from the battery monitoring processing 23 so as to grasp the remaining battery amount level.

Then, the value of a parameter related to selection of a cell is acquired from the record which is referred to and it is determined whether there is a difference between the value of an in-use parameter and the acquired value, in S404. When there is no difference, the processing ends. Conversely, when there is a difference, the measurement control processing 33 changes (updates) the value of a parameter which is used for selection of a cell to the value which is acquired from the referred record (a cell selection data pattern) of the cell selection data table T (S405).

When the mobile terminal 1 is in a standby state in S405, the value of a cell reselection priority is updated among parameters of cell reselection, as is the case with S306. Conversely, when the mobile terminal 1 is communicating, in S405, among parameters related to the measurement report the value of an event threshold value which is a trigger of a measurement report is updated. Accordingly, the processing related to updating ends.

<Cell Reselection>

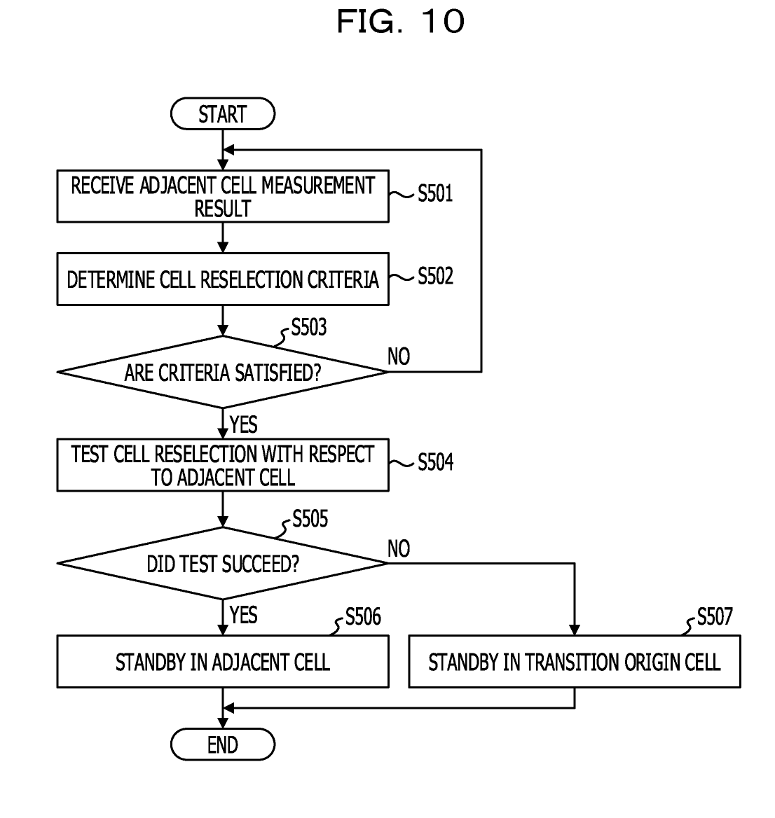

FIG. 10 illustrates an example of processing of the application CPU 12 and the communication CPU 13 related to reselection of a standby cell in the mobile terminal 1.

In S501, the measurement control processing 33 acquires information about radio field intensity and quality of a serving cell and an adjacent cell, via the radio communication I/F control processing 34. Then, the measurement control processing 33 determines whether criteria of cell reselection are satisfied, by using a cell reselection parameter and the acquired information, in S502 and S503.

When the criteria of cell reselection are not satisfied, the processing returns to S501. Conversely, when the criteria of cell reselection are satisfied, the processing proceeds to S504. When updating of a parameter of cell reselection is performed as illustrated in FIG. 8 or 9 before the execution of S502, a value which is set in a cell selection data pattern is used for determination of cell reselection. Accordingly, a power-saving effect may be obtained in the present embodiment.

In S504, the cell selection control processing 31 tries cell reselection with respect to an adjacent cell. When the trial of cell reselection is successful (“YES” in S505), the mobile terminal 1 goes into a standby state for the corresponding adjacent cell (S506). Conversely, when the trial of cell reselection fails (“NO” in S505), the mobile terminal 1 goes into a standby state in the original cell (S507). Accordingly, the processing of cell reselection ends.

<Hand-Over>

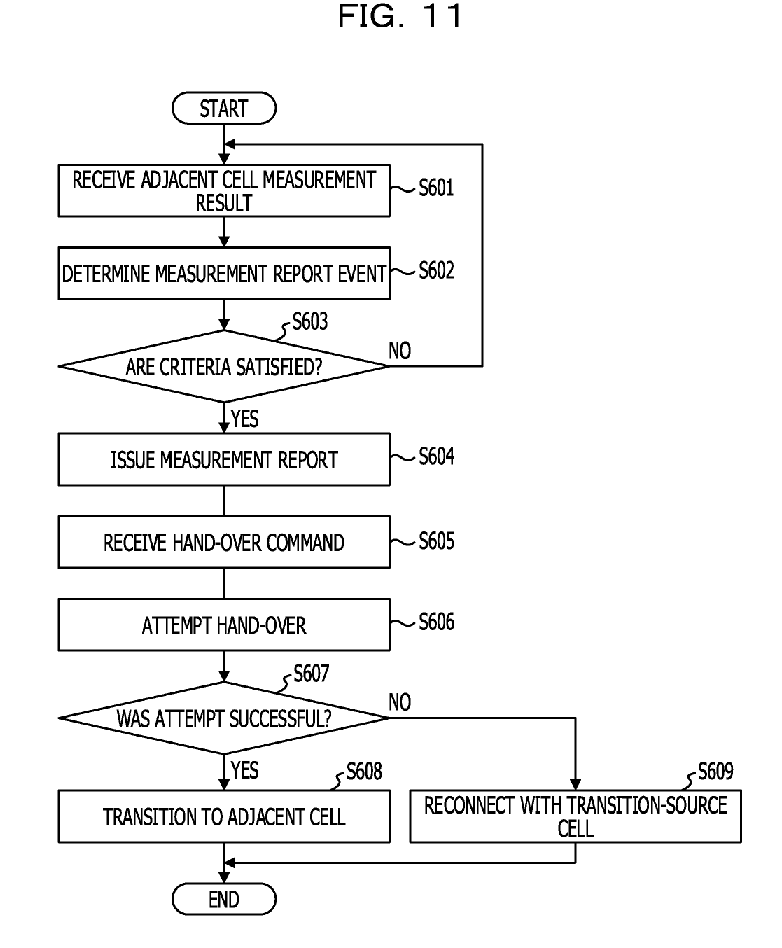

FIG. 11 illustrates an example of processing of the application CPU 12 and the communication CPU 13 related to hand-over in the mobile terminal 1.

In S601, the measurement control processing 33 acquires information about radio field intensity and quality of a serving cell and an adjacent cell, via the radio communication I/F control processing 34. Then, the measurement control processing 33 determines whether criteria for provision of a measurement report are satisfied, by using a parameter related to the measurement report and the acquired information, in S602 and S603.

When updating of a parameter related to the measurement report is performed as illustrated in FIG. 8 or 9 before the execution of S602, a value which is set in a cell selection data pattern is used for determination of the measurement report. Accordingly, a power-saving effect is obtained in the present embodiment.

When the criteria of a measurement report are not satisfied, the processing returns to S601. Conversely, when the criteria of a measurement report are satisfied, the processing goes to S604.

In S604, the measurement control processing 33 controls the radio communication I/F control processing 34 and provides the measurement report to a base station. In response to the provision of the measurement report, the base station returns a hand-over command to the mobile terminal 1. In S605, the cell selection control processing 31 receives the command via the radio communication I/F control processing 34.

In S606, the cell selection control processing 31 tries hand-over with respect to an adjacent cell. When the trial of hand-over is successful (“YES” in S607), the serving cell of the mobile terminal 1 shifts to the corresponding adjacent cell (S608). Conversely, when the trial of hand-over succeeds (“NO” in S607), the mobile terminal 1 reconnects to the original cell (S609). Accordingly, the processing of hand-over end0073.

<Other Processing>

A cell selection data pattern is used in cell search when the mobile terminal 1 is positioned in an outside of a service area, as well. For example, the measurement control processing 33 reads saving mode data from the storage device 11 before performing the cell search. Then, the measurement control processing 33 refers to the saving mode data which is read and determines whether a battery saving function is “ON”.

When the battery saving function is not “ON”, the measurement control processing 33 executes cell search by using a method of the related art. Conversely, when the battery saving function is “ON”, the measurement control processing 33 reads from the storage device 11 a cell selection data table T corresponding to the type of a RAT related to a cell in which the mobile terminal 1 is present and a saving mode which is designated in the saving mode data.

Further, the measurement control processing 33 inquires about the remaining amount level of the battery 14 from the battery monitoring processing 23 and grasps the remaining battery amount level. Subsequently, the measurement control processing 33 refers to a record (a cell selection data pattern) corresponding to the remaining battery amount level notified from the battery monitoring processing 23, from in the cell selection data table T which is read.

Then, the measurement control processing 33 executes cell search in accordance with the configuration of a preferential RAT in the record which was referred to. Specifically, the measurement control processing 33 searches a cell under the preferential RAT which was set in the record which was referred to. Thus, cell search is executed in the mobile terminal 1 of the embodiment in the above manner.

Here, as another embodiment of the mobile terminal 1 according to the present embodiment, an information processing method which realizes the above-described respective elements, a program, and a recording medium which is readable by a computer which stores the program, another device, or machine is applicable. Here, the recording medium which is readable by a computer and the like is a medium which accumulates information such as a program by an electrical-, magnetical-, optical-, mechanical-, or chemical-action.

According to the above-described embodiment, it is possible to select a cell of an appropriate radio access technology while taking the operating state of a mobile terminal into account.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A mobile terminal, comprising:
a memory configured to store a cell selection data pattern, the cell selection data pattern being used to select a radio access technology utilized by the mobile terminal, in a manner to associate the cell selection data pattern with an operating state capable of being taken by the mobile terminal; and
a processor coupled to the memory, configured to:
select one of the radio access technologies utilized by the mobile terminal, by using a cell selection data pattern that is selected from the memory based on the operating state of the mobile terminal, and
perform connection processing with respect to a cell by using the selected radio access technology.

2. The mobile terminal according to claim 1, wherein
a priority that is used to control an order of selection of the radio access technologies is set in the cell selection data pattern for each of the radio access technologies capable of being utilized by the mobile terminal, and
the processor is configured to control the order of selection of the radio access technologies utilized by the mobile terminal, by using the priority of each of the radio access technologies that are included in a cell selection data pattern that is selected from the memory based on an operating state of the mobile terminal.

3. The mobile terminal according to claim 1, wherein a priority that is used to control an order of selection of the radio access technologies is set so that while the desirability for an operating state capable of being taken by the mobile terminal to suppress power consumption increases, the priority of a radio access technology exhibiting less power consumption is increased among the radio access technologies that are included in the cell selection data pattern that is associated with the operating state out of the operating states.

4. The mobile terminal according to claim 1, wherein a priority that is used to control an order of selection of the radio access technologies is set so that while the desirability for an operating state capable of being taken by the mobile terminal to suppress power consumption decreases, the priority of a radio access technology exhibiting a higher transmission speed is increased among the radio access technologies that are included in the cell selection data pattern that is associated with the operating state out of the operating states.

5. The mobile terminal according to claim 1, wherein
the operating state capable of being taken by the mobile terminal is at least one of remaining amount of a battery included in the mobile terminal and application functionality utilized by the mobile terminal, and
association between an operating state capable of being taken by the mobile terminal and the cell selection data pattern in the memory satisfies at least one of a relation in which as the remaining amount of the battery included in the mobile terminal becomes smaller the desirability for an operating state capable of being taken by the mobile terminal to suppress power consumption increases, and a relation in which as power consumption of application functionality that is utilized by the mobile terminal increases the desirability for an operating state capable of being taken by the mobile terminal to suppress power consumption increases.

6. The mobile terminal according to claim 5, wherein when the mobile terminal is in standby and the remaining amount level of the battery fluctuates the processor selects a cell selection data pattern that is used to select the radio access technology in accordance with a currently-used function.

7. The mobile terminal according to claim 5, wherein when the mobile terminal is in standby and functionality that is used in the mobile terminal is changed the processor selects a cell selection data pattern that is used to select the radio access technology in accordance with post-change functionality.

8. The mobile terminal according to claim 5, wherein when the mobile terminal is communicating and the remaining amount level of the battery fluctuates the processor selects a cell selection data pattern that is used to select the radio access technology in accordance with currently-used functionality.

9. The mobile terminal according to claim 5, wherein when the mobile terminal is communicating and functionality used in the mobile terminal is changed the processor selects a cell selection data pattern that is used to select the radio access technology in accordance with post-change functionality.

10. The mobile terminal according to claim 1, wherein when the mobile terminal is not present in any of a plurality of cells the processor executes cell search processing with respect to one of the plurality of radio access technologies, the one of the plurality of radio access technologies being designated by preferential radio access technology information stored in the memory, while restricting cell search processing with respect to the rest of the plurality of radio access technologies.

11. The mobile terminal according to claim 6, wherein, as part of parameter setting, the processor rewrites a parameter for cell reselection processing based on a selected cell selection data pattern.

12. The mobile terminal according to claim 6, wherein, as part of parameter setting, the processor rewrites a parameter for hand-over based on a selected cell selection data pattern.

13. The mobile terminal according to claim 1, further comprising:
a user interface that is used to set on and off a battery saving function, by which the parameter setting using the cell selection data pattern is executed.

14. A mobile communication method, comprising:
selecting, based on the operating state of the mobile terminal, one cell selection data pattern among cell selection data patterns, the cell selection data patterns being used to select a radio access technology utilized by the mobile terminal and being stored in a manner to be associated with an operating state capable of being taken by the mobile terminal;
selecting one of a plurality of radio access technologies utilized by the mobile terminal, by using the selected cell selection data pattern; and
performing connection processing with respect to a cell by using the selected radio access technology.

15. A mobile communication system, comprising:
a mobile terminal; and
a base station configured to form a cell and uses one of a plurality of radio access technologies; wherein
the mobile terminal is configured to:
select one cell selection data pattern among cell selection data patterns, the cell selection data patterns being used to select a radio access technology utilized by the mobile terminal and being stored in a manner to be associated with an operating state capable of being taken by the mobile terminal, based on the operating state of the mobile terminal,
select one of radio access technologies utilized by the mobile terminal among the plurality of radio access technologies, by using the selected cell selection data pattern, and
perform connection processing with respect to a cell that is formed by the base station, the base station using the selected radio access technology.
